(19) United States
(12) Patent Application Publication
(10) Pub. No.: US 2003/0034721 A1
(43) Pub. Date: Feb. 20, 2003

(54) Method for improving field emission uniformity from a carbon-based array

(76) Inventors: Henry Windischmann, Sunset Valley, TX (US); Randolph D. Schueller, Austin, TX (US); Byron G. Zollars, Georgetown, TX (US); Keith D. Jamison, Austin, TX (US); Donald E. Patterson, Austin, TX (US); Kent R. Kalar, Austin, TX (US)

Correspondence Address: BAKER BOTTS, LLP, 910 LOUISIANA, HOUSTON, TX, 77002-4995, US

(21) Appl. No.: 09/933,031

(22) Filed: Aug. 20, 2001

(51) Int. Cl. H01J 1/02

(52) U.S. Cl. 313/309

(57) ABSTRACT

An array of carbon-based emitters is provided having more uniform electron emission over the area of the array. This is made possible by a resistive layer that is present below each of the emission tips. Both organic and inorganic resistive layers may be grown under the emitting carbon-based material. A conductive backing layer is in contact with the resistive layer. Methods for making the improved array are provided. The methods include growth of carbon-based tips in a mold, removal of various films or portions of films by etching, and other techniques.

### BACKGROUND OF THE INVENTION

1. Field of the Invention

This invention relates to field emission of electrons. More particularly, apparatus and method for its manufacture are provided for improving emission uniformity across an array of carbon-based emitters.

2. Description of Related Art

Present field emitter arrays tend to have non-uniform current emission from tips in the array. This deficiency is caused by slight variations in the geometry and work functions of the emitter tips and variations in extraction gate sizes. Accordingly, only five to ten percent of the emitter tips in an array normally carry the current supplied from the array while the remainder of the tips are inactive. The relatively large amount of current passing through some of the emitting tips shortens the lifetime of the tips and the array overall.

Another drawback to existing array designs is their susceptibility to arcing or catastrophic failure. Failure can occur when an event such as a gas burst caused by a backscattered ion initiates a plasma discharge. The plasma discharge can destroy one or more individual tips and gates.

These problems have been alleviated in applications using Spindt tips through the use of a resistive layer to balance the current between tips and pinch off current flow during micro-discharges. For manufacturing techniques where the tips are deposited onto a substrate, current technology allows for a resistive layer to be deposited on the substrate prior to the deposition of the tips. For example, U.S. Pat. Nos. 6,091,188, 6,084,341, 6,060,823, 6,031,322, 5,910,701, 5,905,330, 5,894,187 and 4,940,916 disclose emitter arrays with a resistive layer beneath the Spindt tips.

Where carbon-based emitter tips are fabricated through the deposition or growth of material in a mold, such as that disclosed in U.S. Pat. No. 6,132,278, there is a need for apparatus and method for producing a reliable resistive layer to make possible field emitter arrays with more evenly distributed emission current.

### SUMMARY OF THE INVENTION

The present invention provides a field emission apparatus with improved emission uniformity across an array of carbon-based emitters and a method for the manufacture of the apparatus. In one embodiment, apparatus having a layer with an electrical resistance greater than the resistance of the array of emitter tips is in contact with the bottom of emitting tips. The resistive layer is also in contact with an electrically conductive backing layer. In accordance with a second embodiment, the resistive layer is a resistive carbon-based layer that is grown integrally with the carbon-based -emitting material. In yet another embodiment, a thin layer of emitting material is present between the resistive layer and the emitting tips.

The invention further provides methods for making arrays of carbon-based emitters having a resistive layer. One method begins with the formation of a mold with an array of indentations or pits on a selected surface of the mold. An array of tips of carbon-based material is formed when a layer of carbon-based material is grown on the mold to fill the pits with carbon-based material and produce a layer of excess carbon-based material. The layer of excess carbon-based material may then be completely removed from the mold and a resistive layer of material with greater resistance than the emitting tips may be deposited on the mold and remaining carbon-based material. An electrically conducting support or backing layer is placed in contact with the resistive layer. Finally the mold is removed to expose the tips of the carbon-based material. In another embodiment, a thin conducting layer is formed, which may be the emitting material, and remains between the resistive layer and the tips.

In another method for making the apparatus, the resistive layer is resistive carbon that is integrally formed with the layer of emitting material. In yet another method for making, carbon-based emitting tips are formed by growing on diamond seed material in pits in a mold. No excess carbon-based material layer is grown. A resistive layer is then grown over the isolated pits, a conductive layer is placed over the resistive layer and the mold is removed to leave exposed emitting tips.

### DESCRIPTION OF THE FIGURES

For a more complete understanding of the invention and the advantages thereof, reference is now made to the following description taken in conjunction with the following drawings in which the like reference numbers indicate like features and wherein:

FIG. 1 shows a silicon mold with inverse pyramidal depressions.

FIG. 2 shows a silicon mold with a thin, continuous carbon-based film.

FIG. 3 shows a silicon mold and carbon-based tips after the excess carbon-based material is removed.

FIG. 4 shows a silicon mold and carbon-based tips after a resistive layer is added.

FIG. 5 shows carbon-based tips, a resistive layer, and a backing layer after the mold is removed.

FIG. 6 shows a silicon mold with carbon-based films of varying resistance.

FIG. 7 shows carbon-based films of varying resistance after the mold is removed with an aluminum layer deposited on the tip side of the carbon-based film.

FIG. 8 shows a layer of photoresist deposited on top of the aluminum layer once the photoresist is etched to reveal the aluminum layer on the tips.

FIG. 9 shows a titanium layer deposited on top of the aluminum and remaining photoresist.

FIG. 10 shows a titanium layer coating the tips after the photoresist is removed.

FIG. 11 shows tips and the resistive layer after the aluminum and conductive carbon-based material are etched.

FIG. 12 shows the resulting emitter after the titanium is removed from the tips.

FIG. 13 shows a device with isolated tips and a self-aligned gate layer.

FIG. 14 shows the silicon mold with isolated carbon-based tips grown into the pyramidal depressions.

FIG. 15 shows the carbon-based tips in the mold after a resistive layer has been added to the back side of the tips.

FIG. 16 shows the carbon-based tips in the mold after a backing layer has been added to the back side of the resistive layer.

FIG. 17 shows a device structure.

### DESCRIPTION OF PREFERRED EMBODIMENTS

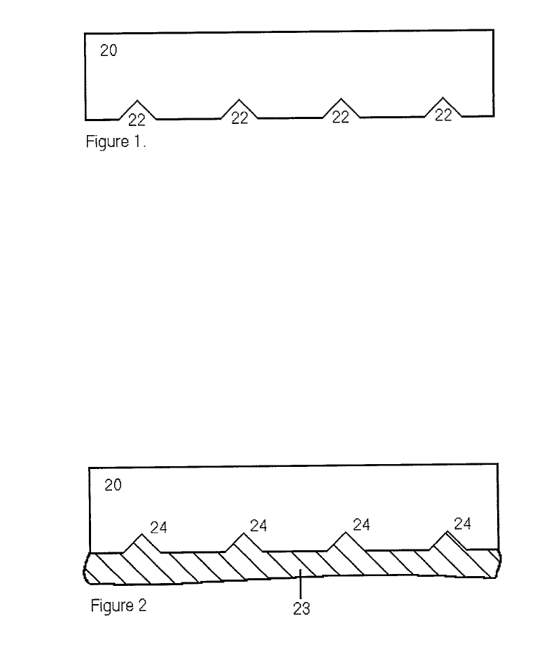

In a first embodiment of the apparatus, a resistive layer is in contact with the bottom of a layer of emitting material having molded emitter tips. The process of making this structure begins with forming a mold in which the layer of emitting material will be grown. FIG. 1 shows mold 20, which may be formed from silicon and may be produced using the following standard photolithographic techniques. Initially, a thin silicon oxide or silicon nitride film is grown onto the surface of a silicon wafer. A template is then created by etching a plurality of openings through the oxide film using standard photolithographic processes. The openings may be in the range of about 2 microns per side and the openings are preferably arranged in groups such that each group forms an array having a selected number of openings. After the aperture areas are defined in the template, the silicon oxide film is isotropically etched in a buffered hydrofluoric acid mixture to form apertures in the oxide layer. The exposed silicon within the apertures is then anisotropically etched using a mixture of potassium hydroxide and normal propanol to produce pits or inverted pyramids 22 in the silicon. This process forms the basic mold on which the carbon-based emitter tips will be grown. After the pits are formed, the remaining silicon oxide film is removed and the wafer is nucleated for carbon-based film growth using standard techniques.

Next, mold 20 is placed in a Chemical Vapor Deposition (CVD) growth reactor. A commercially-available reactor such as an ASTeX 5 kW Microwave CVD Reactor may be used to grow a carbon-based film on mold 20. Growth conditions for such a carbon-based film are described in U.S. Pat. No. 6,181,055B1 and in co-pending patent application Ser. No. 09/169,908, which are hereby incorporated by reference herein. Such films contain a mixture of sp₂ and sp₃ carbon bonds, and are sometimes referred to herein as “diamond” and sometimes as “carbon-based.” It should be understood that the carbon-based material may be any film grown by the methods described in the documents incorporated by reference or by any other methods forming a carbon-based film having electron emission properties. As shown in FIG. 2, carbon-based material is grown on mold 20 in the diamond reactor. This material forms both emitter tips 24 in the mold and layer 23 of excess carbon-based material connecting the tips on what will become the back side.

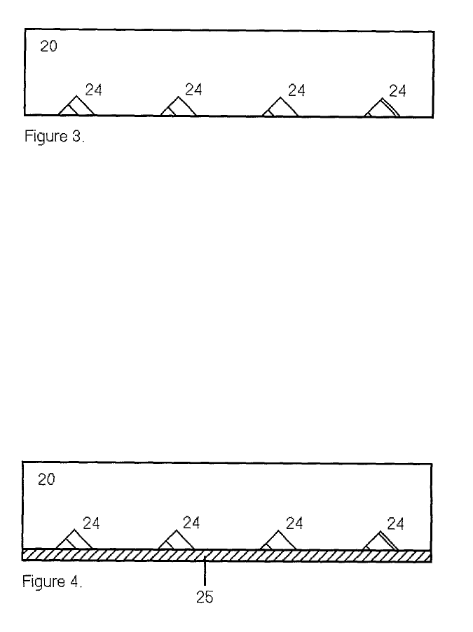

After the carbon-based film growth is complete, the excess layer 23 of carbon-based material on the back side is removed by polishing the back side down to the plane of silicon mold 20, leaving tips 24, as shown in FIG. 3.

FIG. 4 shows a thin layer of resistive material 25, preferably sputter-deposited polysilicon, formed on mold 20 and the back side of diamond tips 24. Other materials such as doped silicon carbide, amorphous silicon, or high-resistance carbon (diamond) may also be used. Resistive layer 25 should have a resistance through the layer between about 1,000 ohms and about 5,000,000 ohms for a 10 square micron cross section and a thickness between about 0.5 and about 50 microns. For high-resistance carbon, the resistance may be in the range of 1,000 to 10,000,000 ohms for a 10 square micron cross section. The higher the resistance of this resistive layer, the more uniform emission current will be across a particular array; however, increasing the resistance of the resistive layer can broaden the energy distribution of electrons emitted from the gated device.

Then, referring to FIG. 5, conducting backing layer 26, which may be formed from silicon or carbon, for example, is attached to the resistive layer. Backing layer 26 can be deposited directly onto resistive layer 25 or independently fabricated and bonded, sintered, adhered, welded or alloyed to resistive layer 25. Finally, silicon mold 20 is removed using well-known techniques, leaving carbon-based tips 24 attached to resistive layer 25 and supported by backing layer 26, as shown in FIG. 5.

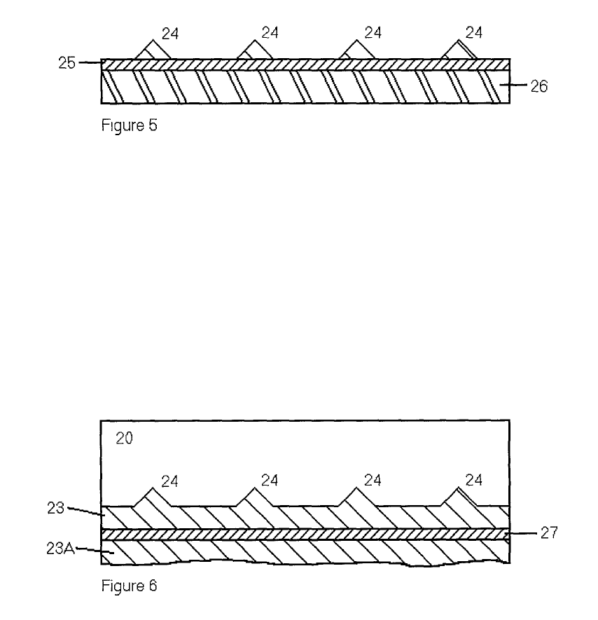

A second embodiment of this invention involves controlling conditions during the growth process of the carbon-based material growth process to produce an intermediate layer of high-resistance carbon-based material. In FIG. 6, mold 20 is created as in the first embodiment. It may then be placed into an ASTeX 5 kW Microwave CVD reactor, as previously described. Initially, the carbon-based material of layer 23 should be grown in conditions such that it is conductive and emissive. Again, growth conditions for conductive carbon-based material are taught in U.S. Pat. No. 6,181,055B1 and in Ser. No. 09/169,908.

After layer 23 is formed, film growth conditions are changed to enable the growth of layer 27 of carbon-based material, which is much less conductive than the material in layer 23. Optimally, resistive layer 27 will be less than about two microns thick and have a resistance through the film on the order of 100,000 to 1,000,000 ohms for a 10 square micron cross-section, but may have a resistance in the range of about 1,000 ohms to about 10,000,000 ohms for a 10 square micron cross-section. Growth conditions for producing such high-resistance films are also taught in U.S. Pat. No. 6,181,055B1 and in Ser. No. 09/169,908.

After layer 27 is complete, growth conditions may be changed again to produce higher conductivity carbon-based material, indicated in FIG. 6 as layer 23A. Once the diamond growth is complete, silicon mold 20 is removed to expose tips 24. An advantage of the isolated tips 24 and layer 23 grown in conjunction with a diamond resistive layer 27 and the conductive diamond layer 23A is that the entire structure can be grown in a single deposition cycle, with no further processing required, to produce isolated conductive diamond tips.

At this point, conductive carbon-based material in layer 23 will join tips 24. In one embodiment, this layer may be grown with limited thickness, such that electrical resistance between tips will be sufficiently large to achieve an effective amount of emission uniformity, even though the tips are not connected directly to a resistive layer. An effective amount of emission uniformity may be determined by observing the variation of emission current over an array of emitters, using well known techniques. Layer 23 of FIG. 6 may have a thickness in the range from about 1 micron to about 10 microns; the preferred thickness will vary with resistivity of layer 23. Preferably, the resistance will be in the range from about 10 to about 5,000,000 ohms for a 10 square micron cross-section.

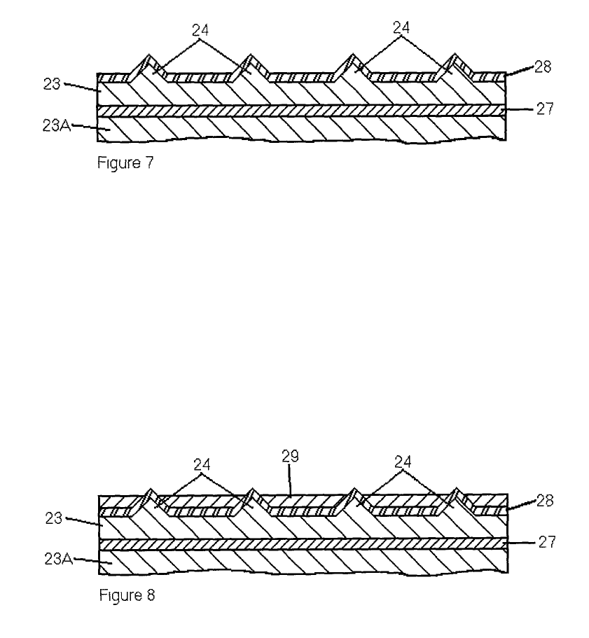

In another embodiment, the layer of conductive material between tips is removed, such that each emitter tip is electrically connected only to resistive layer 27. FIG. 7 shows the first step of this removal process. Aluminum layer 28 is deposited on tips 24 and layer 23 of carbon-based material. Other materials such as nickel may be used in place of aluminum. Next, referring to FIG. 8, photoresist 29 is spun onto the surface of aluminum layer 28 and baked. The photoresist will be thinner over the tops of the tips than in between the tips due to the photoresist spinning process. Dry etching may then be used to remove the photoresist to reveal aluminum layer 28 over the tips, as shown in FIG. 8.

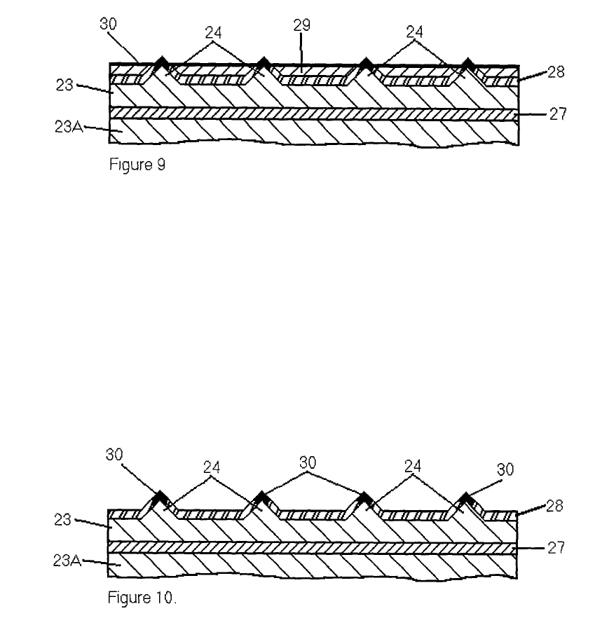

Next, referring to FIG. 9, the exposed aluminum-covered tips are wet etched to remove the aluminum and leave a surface of carbon-based material on tips 24 and a surface of photoresist 29 between the tips. Protective layer 30, which may be formed from titanium, gold or other similarly reactive materials, is then vapor-deposited onto the tips and remaining photoresist 29. As shown in FIG. 10, removing the remaining photoresist 29 will leave protective layer 30 only on tips 24 and expose aluminum layer 28 between the tips.

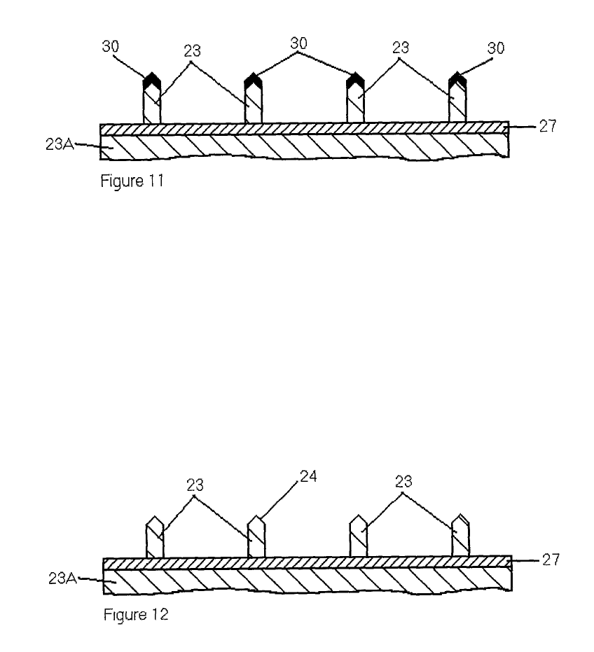

In FIG. 11, the remaining aluminum layer has been wet etched to expose the surface of the underlying layer 23 of carbon-based material between tips 24. Also, the layer 23 of carbon-based material has been dry etched between tips to expose layer 27 of resistive diamond between tips. During this dry etching step, protective layer 30 protects carbon-based material in tips 24 such that they are not etched. Finally, FIG. 12 shows conductive diamond tips 24 after protective layer 30 has been removed. The tips 24 now have less of a pyramidal shape and sides more nearly perpendicular to resistive diamond layer 27. A layer 23A of carbon-based material with higher conductivity than layer 27 may serve as an electrically conductive support for the structure. Alternatively, layer 23A may be attached to other electrically conductive support materials such as layer 26 of FIG. 5.

After the structure of FIG. 5 or of FIG. 12 is formed with a resistive layer in contact with carbon-based emission tips 24, an array of tips may be used as a source of electrons by placing an anode in proximity to the tips and supplying a voltage between the array and the anode.

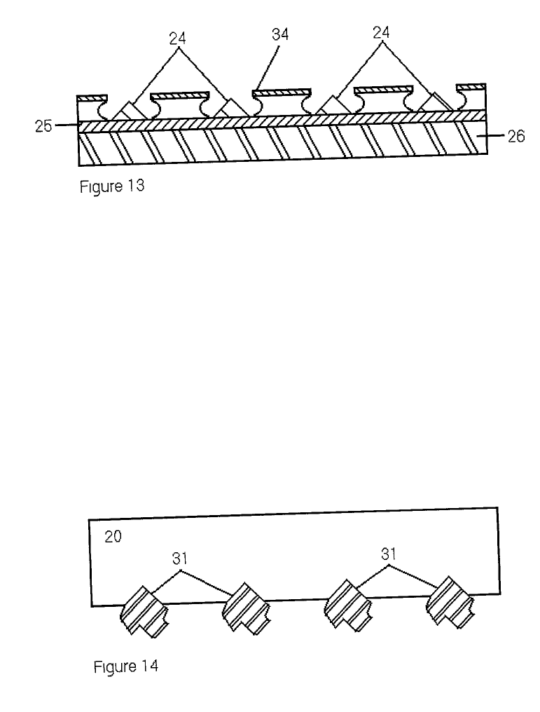

FIG. 13 depicts an alternative structure with self-aligned gates 34 formed in proximity to tips 24. The gate structure may be formed by any process for forming self-aligned gates, such as those described in U.S. Pat. No. 6,181,055 and patent application Ser. No. 09/169,908.

In yet a third embodiment of the present invention, isolated diamond tips are deposited in the pits of a silicon mold. Mold 20 of FIG. 1 is produced, as explained previously, by etching through a silicon oxide film on a silicon wafer to produce pits that may be in the shape of inverted pyramids 22. In this third embodiment, the silicon template is seeded with a proper nucleating agent such as diamond powder before the silicon oxide film is removed from the wafer area surrounding the pits. Seed particles between the pits are then removed as the silicon oxide hard mask is removed. By this procedure, the nucleation can be confined to the pits. A short growth period in a diamond reactor results in isolated diamond tips 31 in the pits, as shown in FIG. 14. An ASTeX 5 kW Microwave CVD Reactor may be used. Growth conditions are preferably as disclosed in U.S. Pat. No. 6,181,055B1 or U.S. patent application Ser. No. 09/169,908.

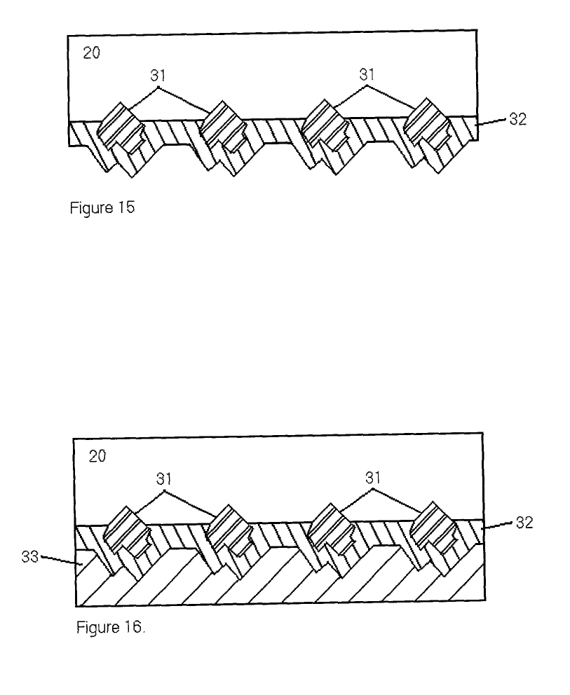

After growth of isolated tips 31, resistive layer 32 is deposited onto the back of the tips, as depicted in FIG. 15. Preferably, the resistive layer is silicon carbide or diamond. The through-resistance of the resistive layer is preferably between about 1,000 ohms and about 5,000,000 ohms for a 10 square micron cross section and its thickness is preferably in the range from about 0.5 to about 2 microns.

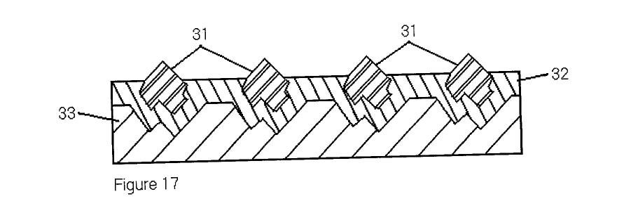

After the thin resistive layer is deposited, thick backing layer 33 is deposited, adhered, welded, bonded or sintered on the resistive layer, as shown in FIG. 16. The thick backing layer is preferably polysilicon or carbon. Finally, the silicon mold is removed, using well-known procedures. The final tip structure having a resistive layer is shown in FIG. 17.

While particular preferred embodiments of the present invention have been described, it is not intended that these details should be regarded as limitations upon the present invention, except as and to the extent they are included in the following claims.

What we claim is:

1. An apparatus for field emission of electrons, comprising:
an array of carbon-based emitter tips;
a resistive layer contacting the array of emitter tips on a first side of the resistive layer, the resistive layer having an electrical resistance greater than the array of emitter tips and being electrically connected to the array of emitter tips through the resistive layer so as to limit electrical current flow through a carbon-based emitter tip; and
an electrically conductive backing layer in contact with a second side of the resistive layer.

2. The apparatus of claim 1 wherein the resistive layer is formed from an inorganic material.

3. The apparatus of claim 1 wherein the resistive layer has an electrical resistance in the range from about 1,000 ohms to about 10,000,000 ohms for a 10 square micron cross section.

4. The apparatus of claim 1 wherein the resistive layer has an electrical resistance in the range from about 100,000 ohms to about 1,000,000 ohms for a 10 square micron cross-section.

5. The apparatus of claim 2 wherein the inorganic material is polysilicon or doped silicon carbide.

6. The apparatus of claim 2 wherein the inorganic material is amorphous silicon.

7. The apparatus of claim 2 wherein the resistive layer has a thickness in the range from about 0.5 microns to about 50 microns.

8. The apparatus of claim 1 wherein the carbon-based emitter tips comprise diamond.

9. An apparatus for field emission of electrons, comprising:
an array of carbon-based emitter tips;
a layer of electrically conductive material having a thickness and resistance to provide an effective amount of emission uniformity contacting the emitter tips on a first side of the layer of electrically conductive material;
a first side of a resistive layer contacting a second side of the layer of electrically conductive material; and
an electrically conductive backing layer contacting a second side of the resistive layer.

10. The apparatus of claim 9 wherein the resistive layer is formed from an inorganic material.

11. The apparatus of claim 9 wherein the resistive layer has an electrical resistance in the range from about 1,000 ohms to about 10,000,000 ohms for a 10 square micron cross section.

12. The apparatus of claim 10 wherein the inorganic material is polysilicon or doped silicon carbide.

13. The apparatus of claim 10 wherein the resistive layer is formed from a carbon-based material grown under conditions to produce a resistance across the layer in the range from about 1000 ohms to about 10,000,000 ohms for a 10 square micron cross section.

14. A method for making an array of carbon-based electron emitter tips, comprising:
providing a mold having an array of pits on a selected surface of a wafer, the pits being such as to produce an array of tips of carbon-based material when a layer of carbon-based material is grown on the selected surface of the wafer;
growing the layer of carbon-based material on the selected surface so as to fill the pits with the carbon-based material to form the array of tips and to produce a layer of excess carbon-based material on the selected surface of the mold;
depositing a resistive layer;
placing an electrically conducting backing layer in contact with the resistive layer; and
removing the mold so as to expose the tips of the carbon-based material.

15. The method of claim 14 further comprising the step of removing the layer of excess carbon-based material before the step of depositing a resistive layer.

16. The method of claim 14 wherein the mold is formed from silicon.

17. The method of claim 14 wherein the step of depositing a resistive layer comprises the step of growing a layer of resistive carbon-based material.

18. The method of claim 15 wherein the step of depositing a resistive layer comprises the step of depositing an inorganic layer.

19. The method of claim 14 wherein the step of providing a mold comprises:
growing a first film of silicon oxide or silicon nitride on the selected surface of the wafer;
etching a template of an array of apertures through the first film;
etching the wafer through the array of apertures to produce the array of pits in the wafer; and
removing the first film.

20. The method of claim 14 wherein the array of pits on the selected surface of the wafer is etched so as to form a plurality of groups of pits such that each group forms an array having a selected number of pits.

21. The method of claim 18 wherein the inorganic material is sputter-deposited polysilicon or doped silicon carbide.

22. The method of claim 14 wherein the resistive layer has a resistance between 1,000 and 5,000,000 ohms for a 10 square micron cross section.

23. The method of claim 14 wherein the resistive layer has a thickness of between 0.5 and 50 microns.

24. The method of claim 14 wherein the backing layer is primarily silicon or carbon.

25. The method of claim 14 wherein the backing layer is placed in contact with the resistive layer by direct deposition onto the resistive layer.

26. The method of claim 14 wherein the backing layer is placed in contact with the resistive layer by independently fabricating the backing layer and bonding, sintering, adhering, welding, or alloying the backing layer to the resistive layer.

27. A method for making an array of carbon-based electron emitter tips, comprising:
providing a mold having an array of pits on a selected surface of a wafer, the pits being such as to produce the array of carbon-based electron emitter tips when a layer of carbon-based material is grown on the selected surface of the wafer;
growing the layer of carbon-based material on the selected surface under growth conditions such that the carbon-based material is conductive and so as to fill the array of pits and produce the array of carbon-based emitter tips and an excess layer of conductive carbon-based material on the selected surface of the mold;
changing growth conditions of the carbon-based material during the growth process after the excess layer of conductive carbon-based material is formed so as to grow a resistive layer of carbon-based material;
changing growth conditions of the carbon-based material during the growth process after the resistive layer is formed so as to produce a backing layer of conductive carbon-based material;
removing the mold so as to expose the array of carbon-based emitter tips; and
removing a portion of the excess layer of conductive carbon-based material, the portion being the excess layer of conductive carbon between tips, such that the array of carbon-based emitter tips is electrically connected only to the resistive layer.

28. The method of claim 27 wherein the resistive layer is grown to a thickness less than about 2 microns.

29. The method of claim 27 wherein the resistive layer is grown to have a resistance in the range from 1,000 ohms to 5,000,000 ohms for a 10 square micron cross section.

30. The method of claim 27 wherein the step of removing the portion of excess layer of conductive carbon-based material comprises:
depositing a layer of aluminum or nickel on the tips and the portion of excess layer, the layer of aluminum or nickel having a first and a second portion;
spinning a layer of photoresist on the layer of aluminum or nickel, the layer of photoresist having a first and a second portion;
dry etching to remove the first portion of the layer of photoresist, the first portion of the layer of photoresist being the photoresist over the tips;
wet etching to remove the first portion of the layer of aluminum or nickel, the first portion being the layer of aluminum or nickel over the tips;
depositing a protective layer on the tips and the second portion of the layer of photoresist;
removing the second portion of the layer of photoresist;
wet etching to remove the second portion of the layer of aluminum or nickel;
dry etching between the tips; and
removing the protective layer on the tips.

31. A method for making an array of carbon-based electron emitter tips, comprising:
providing a mold having an array of pits on a selected surface of a wafer, the wafer having a layer of silicon oxide on the selected surface;
seeding the array of pits with a diamond nucleating agent;
removing the layer of silicon oxide;
growing carbon-based material within the array of pits to produce the array of carbon-based electron emitter tips;
growing a resistive layer on the selected surface of the mold to join the array of carbon-based electron emitter tips;
placing a backing layer in contact with the resistive layer; and
removing the mold so as to expose the array of carbon-based electron emitter tips.

32. The method of claim 31 wherein the resistive layer is formed of silicon carbide or diamond.

33. The method of claim 31 wherein the resistive layer has a resistance between 1,000 ohms and 5,000,000 ohms for a 10 square micron cross section.

34. The method of claim 31 wherein the resistive layer has a thickness between 0.5 and 2.0 microns.

35. The method of claim 31 wherein the backing layer is deposited, adhered, welded, bonded or sintered on the insulating layer.

36. The method of claim 31 wherein the backing layer is polysilicon or carbon.
